(19) United States
(12) Patent Application Publication
(10) Pub. No.: US 2006/0139222 A1
(43) Pub. Date: Jun. 29, 2006

(54) Signal receiving apparatus for mobile video devices

(75) Inventor: Fa-Yu Chu, Sanchong City (TW)

Correspondence Address: BIRCH STEWART KOLASCH & BIRCH, PO BOX 747, FALLS CHURCH, VA, 22040-0747, US

(73) Assignee: ASIASONIC INTERNATIONAL INDUSTRIAL CO., LTD.

(21) Appl. No.: 11/023,519

(22) Filed: Dec. 29, 2004

(51) Int. Cl. H01Q 1/32

(52) U.S. Cl. 343/713

(57) ABSTRACT

A signal receiving apparatus for a mobile video device in vehicles has an antenna embedded in a removable non-metal element (such as a bumper or a water tank grille) of a vehicle. The antenna has an exposed second connector corresponding to and coupling with a first connector of the mobile video device. The antenna is hidden in the vehicle without affecting the appearance of the vehicle and provides a desired signal receiving effect. By embedding the antenna in the non-metal element, electromagnetic interference does not occur. The coupled first connector and second connector can transmit signals and facilitate installation and removing.

### FIELD OF THE INVENTION

The present invention relates to a signal receiving apparatus and particularly to a signal receiving apparatus for a mobile video device in vehicles.

### BACKGROUND OF THE INVENTION

With people now pursuing high quality of live, prolific products to fulfill this quality requirement have appeared on the market. For instance, on cars, besides safety and comfort, advanced functions such as satellite navigation system (GPS), high quality stereo or mobile TV also have been developed and installed in many cars to meet consumer's demands. The following discussion specifically targets the mobile TV.

Refer to FIGS. 1 and 2 for a conventional mobile TV used in vehicles. It generally includes a screen 10 and a video box 11 connecting to the screen 10. An antenna 12 is connected to the video box 11 through a cable 120. The antenna 12 now on the market generally can be classified in two types: a flat antenna 12 (as shown in FIG. 1) and a standing antenna 12 (as shown in FIG. 2). The flat antenna 12 has one side coated with an adhesive film for attaching to a desired location when in use. The standing antenna 12 generally has a magnet to be attracted on a desired location in the car. As the steel product will generate electromagnetic interference (EMI) and the paint coated thereon is easily scraped when holding goods, the antenna 12 is preferably not to be mounted on the location made of steel to avoid EMI and affecting aesthetic appealing. Hence the mounting location of the antenna 12 should be selected carefully.

Based on previous discussion, it is clear that there are steel products in a vehicle, such as the vehicle body. The flat antenna 12 is often attached to the windshield or other glass. Such an installation affects driver's vision and driving safety. Moreover, the shielding film or defrosting wires on the windshield will interfere signal receiving quality. The standing antenna 12 is generally mounted onto a shelf below the front windshield or the rear windshield. As it is located inside the vehicle, receiving quality suffers. Some users install the standing antenna 12 outside the vehicle on a non-metal location. It spoils the overall appearance. Moreover, the antenna 12 has to work under wind, rain, and sunshine, hence is aged and damaged easily. There are still a lot of issues to be resolved for the mobile TV in the vehicle.

To overcome the aforesaid problems and improve signal receiving quality, some people have the flat antenna 12 adhered to the front bumper, rear bumper or water tank grille (not shown in the drawings). However, it is difficult to remove and install when the front bumper, rear bumper or water tank grille is damaged. The antenna 12 often has to be removed or cut off. And a new antenna 12 has to be purchased and installed anew. It is costly and time-consuming, and not a desirable way to meet the requirement of the modern society that demands high efficiency.

### SUMMARY OF THE INVENTION

The primary object of the present invention is to solve the aforesaid disadvantages. The present invention provides a signal receiving apparatus for mobile video devices that is hidden and not affected by EMI, and easy to install and remove.

To achieve the aforesaid object, the antenna according to the invention is embedded in a non-metal element outside the vehicle body (such as bumper or water tank grille). The antenna may be a copper wire antenna, a copper blade antenna, a tin foil antenna, a carved copper blade antenna, and the like. The antenna has an exposed second connector corresponding to a first connector of a mobile video device to be coupled therewith to transmit signals between the antenna and the mobile video device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional mobile TV is a vehicle.

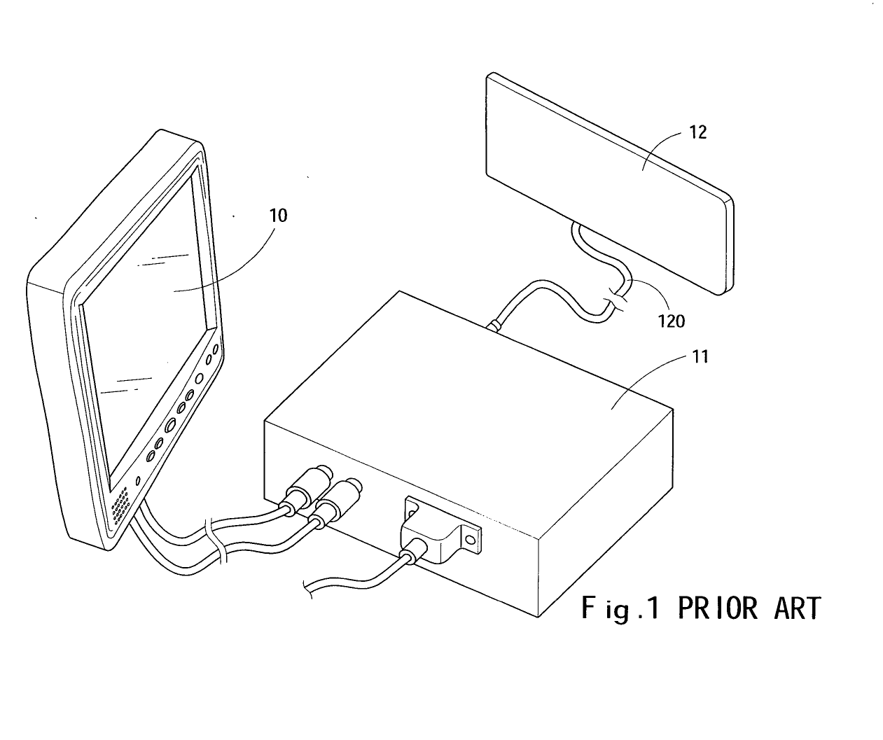

FIG. 2 is a schematic view of another conventional mobile TV is a vehicle.

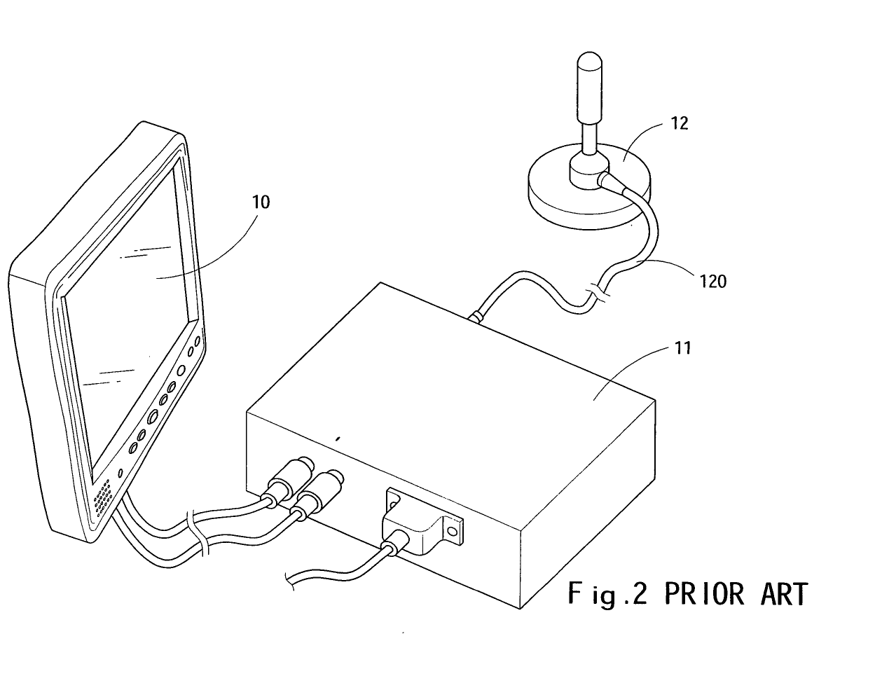

FIG. 3 is a perspective view for connecting a mobile video device according to the present invention.

FIG. 4 is a schematic view of a first embodiment of the invention.

FIG. 5 is a schematic view of a second embodiment of the invention.

FIG. 6 is a schematic view of a third embodiment of the invention.

FIG. 7 is a schematic view of a fourth embodiment of the invention.

FIG. 8 is a schematic view of a fifth embodiment of the invention.

FIG. 9 is a schematic view of a sixth embodiment of the invention.

FIG. 10 is a schematic view of a seventh embodiment of the invention.

### DETAILED DESCRIPTION OF THE PREFERRED EMBODIMENTS

The present invention aims to provide an antenna that is hidden in the vehicle without exposing so that the overall aesthetic appealing remains intact. Details of the invention are discussed as follow.

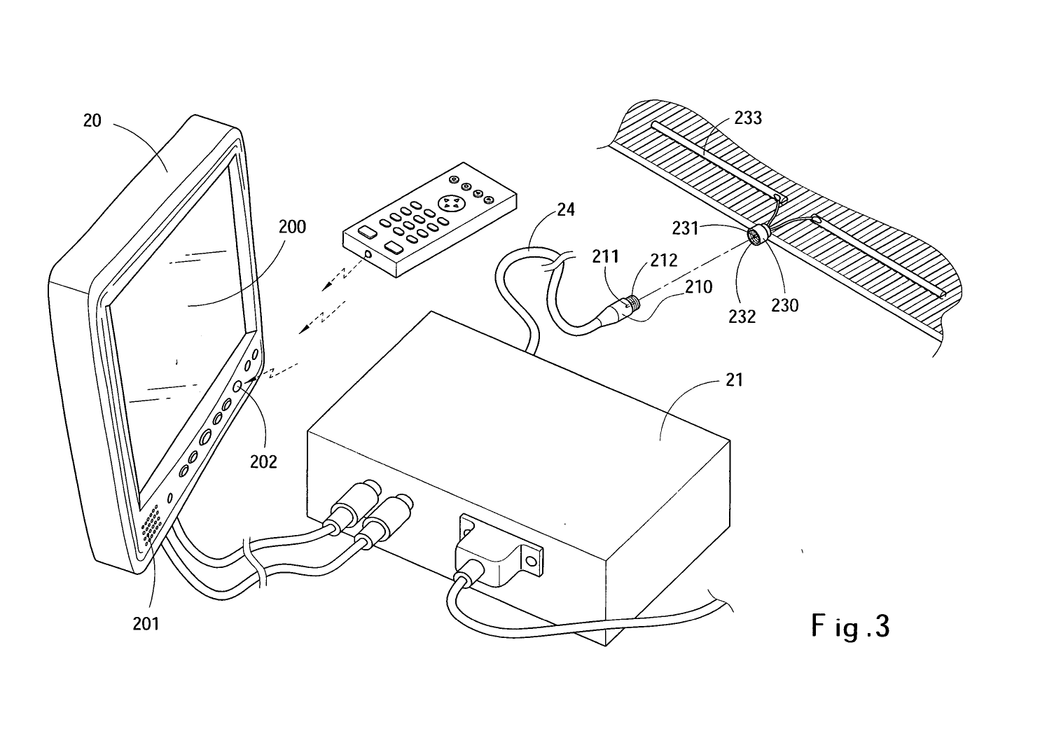

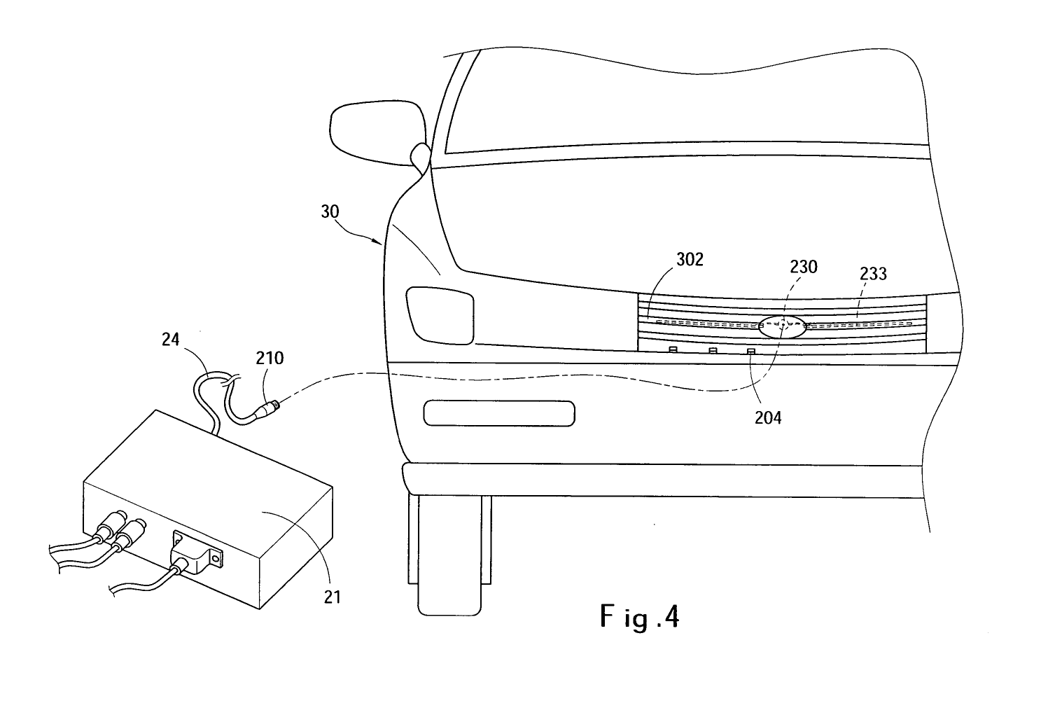

Referring to FIGS. 3, 4 and 5, the mobile video device according to the present invention includes a screen 20 (which includes a display panel 200 and a speaker 201, and an infrared receiver 202) and a video receiver 21 connecting to the screen 20. The mobile video device has a first connector 210 connecting to an antenna 233. The mobile video device is known in the art, thus details are omitted. The following mainly focuses on the features of the invention. The invention aims to embed the antenna 233 in a removable non-metal element on a vehicle body. The antenna 233 has a second connector 230 corresponding to the first connector 210 of the mobile video device. The second connector 230 is exposed to outside the non-metal element and coupled with the first connector 210 (the second connector 230 has a terminal head 231 with an internal screw thread 232 formed therein, while the first connector 210 has an insertion aperture 211 corresponding to the terminal head 231 and an external screw thread 212 corresponding to the internal screw thread 232). Hence the antenna 233 may be connected to the mobile video device to transmit signals therebetween.

There are many types of antenna 233 now on the market. They all may be adopted to the invention. More details of various types of antenna applying to the invention will be discussed later. A vehicle 30 has removable non-metal elements on its body, such as a front bumper 300, a rear bumper 301, or a water tank grille 302 to hold the antenna 233 and the second connector 230 to connect to the first connector 210 of the mobile video device. The second connector 230 is integrally formed by injection and exposed to outside the non-metal element to be connected to the first connector 210 to transmit signals. The first connector 210 is coupled on a distal end of a first transmission line 24 (preferably a cable) of the mobile video device. In order to hold the extra portion of the first transmission line 24 on the vehicle 30, the non-metal element has a plurality of latch trenches 204 to latch the first transmission line 24 after the first connector 210 and the second connector 230 are coupled.

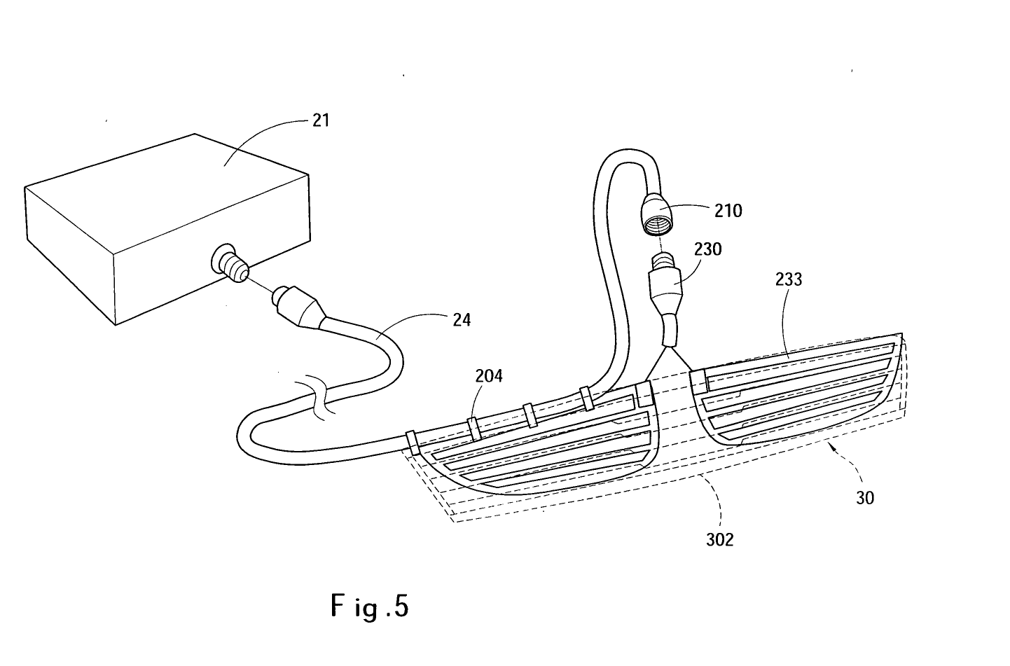

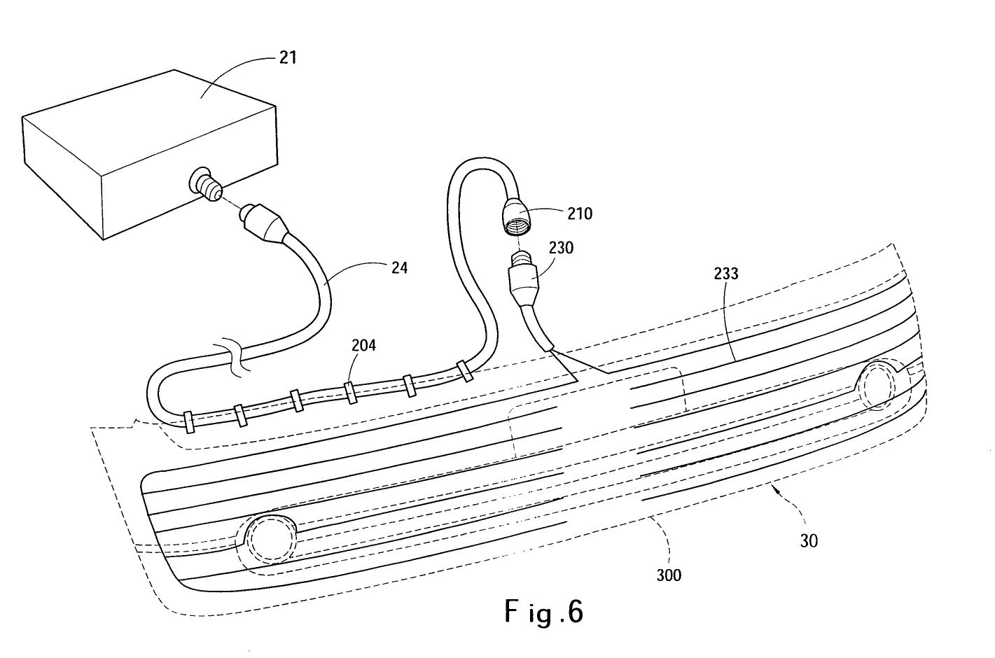

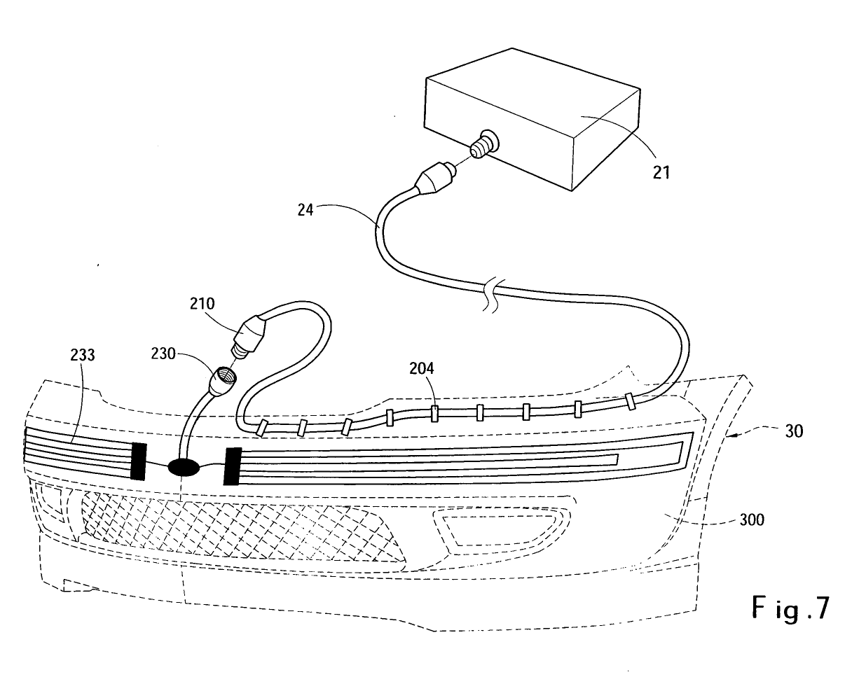

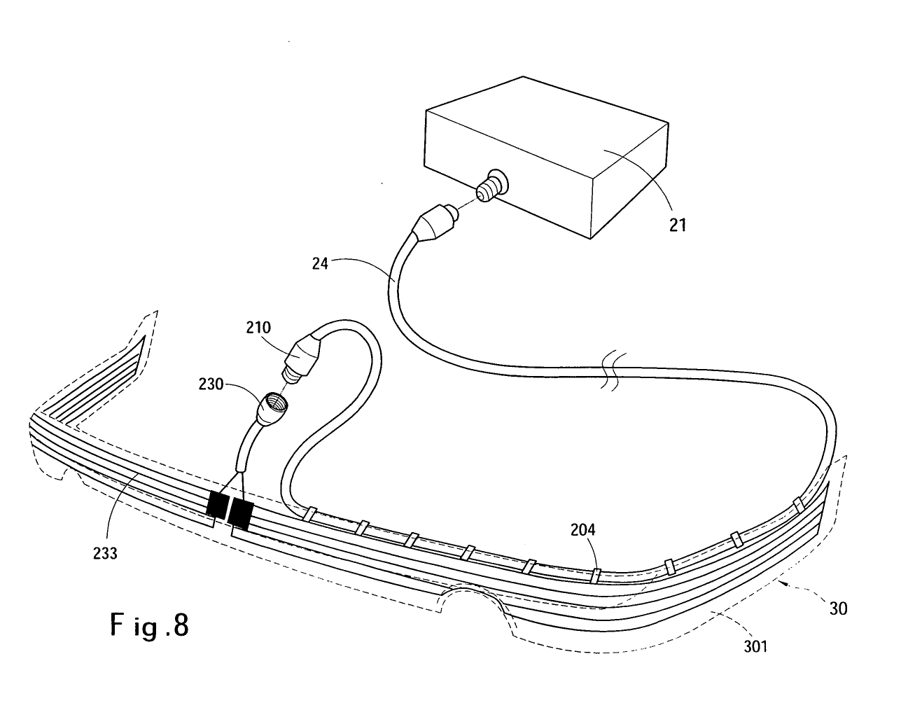

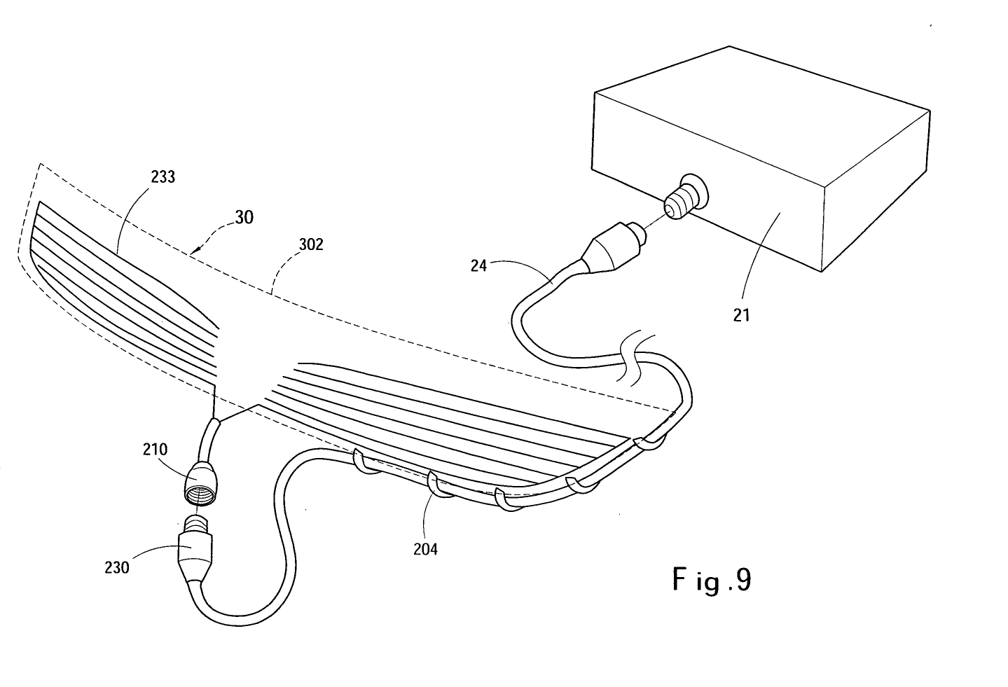

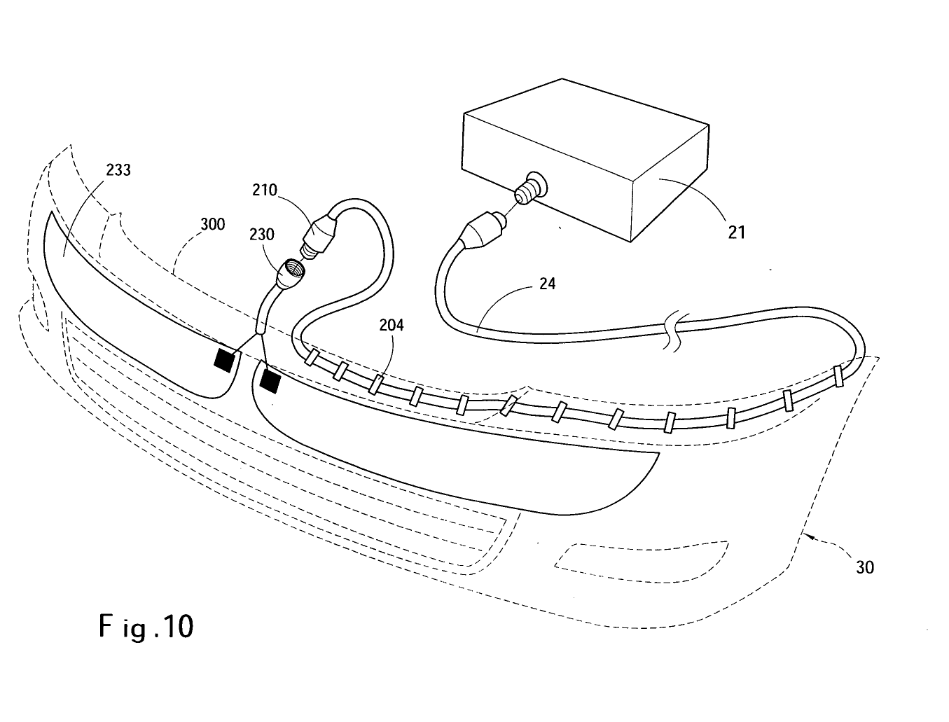

Referring to FIGS. 6, 7 and 10, the antenna 233 is embedded in a removable non-metal element of a vehicle 30. The non-metal element in this embodiment is the front bumper 300. FIG. 8 illustrates another embodiment in which the non-metal element is the rear bumper 301. FIGS. 5 and 9 show yet another embodiment in which the non-metal element is the water tank grille 302. As the water tank grille 302 has a plurality of radiation vanes, the antenna 233 should mate the grille as shown in the drawings so that it may be hidden without hindering cooling of the vehicle 30. The antenna 233 previously discussed mates the removable non-metal element of the vehicle 30 and is formed integrally therewith by injection. The antenna 233 may be a copper wire antenna, a copper blade antenna, a tin foil antenna, a carved copper blade antenna, and the like. The latch trenches 204 for holding the first transmission line 24 also are formed in advance by injection. The latch trenches 204 can hold the first transmission line 24 firmly on the non-metal element (such as the front bumper 300, rear bumper 301 or water tank grille 302) so that the first transmission line 24 does not sway because of shaking of the vehicle 30 during driving or under external forces to prevent poor signal receiving or signal interruption.

In summary, the invention provides the following features and benefits:

1. The antenna 233 is embedded in a non-metal element of the vehicle 30, EMI that might otherwise occur from the metal elements of the vehicle body may be avoided, and signal receiving quality improves.

2. The antenna 233 is embedded in a non-metal element of the vehicle 30 and integrally formed by injection. It is hidden and does not spoil the external appearance of the vehicle 30 as the conventional exposed antenna does. Moreover, the antenna 233 is located in the front bumper 300, rear bumper 301 or water tank grille 302 that is outside the seating area of the vehicle 30, signal receiving effect may be improved.

3. As the antenna 233 and the non-meal element of the vehicle 30 are fabricated integrally, in the event of the non-metal element (such as the rear bumper 301) is damaged, replacement may be made by purchasing and installing another rear bumper 301 equipped with the antenna 233. Installation and removing are easier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A signal receiving apparatus for a mobile video device installed in a vehicle having a first connector;
wherein the vehicle has a removable non-metal element which embeds an antenna, the antenna having a second connector corresponding to the first connector, the second connector being exposed to outside the non-metal element and coupled with the first connector to transmit signals between the antenna and the mobile video device.

2. The signal receiving apparatus of claim 1, wherein the non-metal element is a front bumper of the vehicle.

3. The signal receiving apparatus of claim 1, wherein the non-metal element is a rear bumper of the vehicle.

4. The signal receiving apparatus of claim 1, wherein the non-metal element is a water tank grille of the vehicle.

5. The signal receiving apparatus of claim 1, wherein the mobile video device is connected to a first transmission line which has a distal end coupled with the first connector.

6. The signal receiving apparatus of claim 5, wherein the first transmission line is a cable.

7. The signal receiving apparatus of claim 5, wherein the non-metal element has a plurality of latch trenches corresponding to the first transmission line.

8. The signal receiving apparatus of claim 1, wherein the second connector has a terminal head which has an internal screw thread, the first connector having an insertion aperture corresponding to the terminal head and an external screw thread corresponding to the internal screw thread.

9. A vehicle equipped with a signal receiving apparatus for mobile video devices including a mobile video device which has a first connector, characterized in:
the vehicle having a removable non-metal element which embeds an antenna, the antenna having a second connector corresponding to the first connector, the second connector being exposed to outside the non-metal element and coupled with the first connector to transmit signals between the antenna and the mobile video device.

10. The vehicle of claim 9, wherein the non-metal element is a front bumper of the vehicle.

11. The vehicle of claim 9, wherein the non-metal element is a rear bumper of the vehicle.

12. The vehicle of claim 9, wherein the non-metal element is a water tank grille of the vehicle.
